(19) United States
(12) Patent Application Publication
(10) Pub. No.: US 2007/0011398 A1
(43) Pub. Date: Jan. 11, 2007

(54) Method and device for transferring data between a main memory and a storage device

(75) Inventor: Paulus A. W. Van Niekerk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/557,347

(22) PCT Filed: May 17, 2004
(86) PCT No.: PCT/IB04/50712

§ 371 Date: Nov. 21, 2005

(30) Foreign Application Priority Data
May 26, 2003 (EP) 03101516.7

(51) Int. Cl. G06F 13/00; G06F 13/28; G06F 12/00

(52) U.S. Cl. 711/111; 711/113; 711/112

(57) ABSTRACT

This invention relates to a device and a method of representing a transfer of data between a main memory and a storage device in a storage system. The invention uses scatter gather lists to describe the data area of both the main memory and of the storage device that are relevant for the data transfer. Further is a direction indicator used to specify whether the disk location is source and the part of the main memory is destination or the other way around. Preferably a surplus previously un-used bit is used as the direction indicator. In this way, an efficient way of handling read, write and/or modify processes is enabled. Further, no actual data is moved during CPU processing, since only references to the data, i.e. tuples, are copied between SGLs which greatly reduces storage and bandwidth requirements. Further, the invention also relates to an efficient way of performing sector alignment using scatter gather lists where, whereby dependency of the CPU is decoupled from the much slower disk/storage input/output

The invention relates to a method, and a corresponding device, of transferring data between a main memory and a storage device.

A storage device is typically any storage device that can read and possibly write blocks of data Such storage devices are usually block or sector based, i.e. when only a part of a block, sector, etc. is required it must still be read completely, and when only a part of a block, sector, etc. is to be updated/written it must first be read completely, then modified and finally written completely.

In most computer-based systems, the memory of a data buffer can be “scattered,” rather than contiguous. That is, different “fragments” of the buffer may physically reside at different memory locations. When transferring a “scattered” buffer of data from, for example, the main memory of a host computer to a secondary storage device, it is necessary to “gather” the different fragments of the buffer so that they preferably can be transferred to the secondary storage device in a more contiguouag manner. It is commonly known to use a data structure called Scatter-Gather List (SGL) for this purpose. Each element of a Scatter-Gather List points to or references a different buffer fragment, and the list effectively “gathers” the fragments together for the required transfer. A memory controller, such as a Direct Access Memory (DMA) controller, then performs the transfer as specified in each successive element of the scatter-gather list.

In a traditional file/storage system, a buffer cache is typically available allowing for access to data stored in the file/storage system without sector alignment restrictions. However, traditional file/storage systems do not typically allow for scattered data to be stored. An exception are the ‘vwrite’ and ‘vread’ commands on UNIX-like file systems.

For performance reasons, a real time file/storage system (RTFS) does not usually have a buffer cache, and any sector-unaligned writes are usually implemented as a read-modify-write procedure of complete sectors. Sector alignment is the fact that you can only read or write complete sectors and not each byte individually to or from a storage device. As mentioned, SGLs are typically used to describe data locations that are scattered over the main memory space, e.g. in connection with a data transfer to or from disk or main memory locations e.g. by a DMA capable device.

In an RTFS, partial block/sector writes typically result from requirements on persistency of the data, e.g. a time limit and/or a limit on the amount of data lost during a power failure. In connection with data streams and in particular very thin data streams, e.g. CPI (Characteristic Point Information) or other kinds of meta data, this could well result in partial block updates. Another source of partial writes could come from appending data to existing data e.g. recordings in a Personal Video Recorder (PVR) application based on a disc storage device. Partial reads are very common for example in a trick play scenario using a PVR application. A data stream is typically a continuouag flow of data. Once started, no control is needed from middleware. The data transfer will be regulated by the components that are using it Normally there is a buffer mechanism to provide ‘rubber banding’ between source and sink in a stream. Handling of the buffer is the major interface between components that use streaming data.

A previously known way of doing a partial sector update is to execute a command to read the complete block, and wait until the entire block has been read.

Then to modify/combine the data read with the new data, and finally then to execute a command to write the updated block. These three steps are usually part of the same context, i.e. thread, process, task, etc., thereby causing inefficient CPU usage because of the required context switching, and causing inefficient storage device usage. The disk I/O is slow compared to the CPU, whereby the CPU typically will wait for the disk to complete each step before processing the next. The waiting CPU may in this wait state be interrupted by another thread, process, task, etc. thereby causing context switching. Further, if only a single thread, process, task, etc. is available in the CPU then the waiting of the CPU for the slower disk I/O could very well limit the number of sector writes per second. The inefficient storage device usage is caused since, either the read and write commands of the same block are atomic as seen by the device, whereby the throughput of the device is influenced by the inefficient CPU usage, or they are not atomic, whereby other disk requests can intervene. In they are not atomic, additional seek overhead is incurred from and to this same disk block location.

In some cases the impact on the throughput is also dependent on latency, where a big latency results in a big impact on the throughput. Bigger latencies are present in networked storage devices, e.g. SBP-2 over IEEE 1394 or Ethernet based networks.

It is an object of the invention to provide a method (and corresponding device) of data transfer that solves the above-mentioned problems. A further object is to provide this in a simple and efficient way. Another object is to enable scattered data to be read/written from/to a disk of a storage device. Yet a further object is to provide an alternative interface to traditional ATA (Advanced Technology Attactchment)/IDE (Integrated Drive Electronics) read and/or write commands.

This is achieved by a method (and corresponding device) of representing a transfer of data between a main memory and a storage device in a storage system, the storage system comprising a first scatter gather list data structure arranged to comprise zero or more scatter gather list elements referencing a disk location that is either source or destination of the data to be transferred, a second scatter gather list data structure arranged to comprise zero or more scatter gather list elements referencing a part of the main memory that is either source or destination of the data to be transferred, and a direction indicator for each scatter gather list element of the first scatter gather list data structure or for each scatter gather list element of the second scatter gather list data structure, where the direction indicator specifies whether the disk location is source and the part of the main memory is destination or specifies whether the disk location is destination and the part of the main memory is source, the method comprising the step of generating
a first scatter gather list data structure and a second scatter gather list data structure.

In this way, a simple and efficient way of handling read/write operations is provided. Especially in real-time storage systems. Further, no actual data is moved during CPU processing, since only references to the data, i.e. tuples, are copied between SGLs which greatly reduces storage and bandwidth requirements.

Advantageouag embodiments of the method according to the present invention are defined in the sub-claims.

The present invention also relates to a device corresponding to the method according to the present invention.

More specifically, the invention relates to a device for representing a transfer of data between a main memory and a storage device in a storage system, the storage system comprising a first scatter gather list data structure arranged to comprise zero or more scatter gather list elements referencing a disk location that is either source or destination of the data to be transferred, a second scatter gather list data structure arranged to comprise zero or more scatter gather list elements referencing a part of the main memory that is either source or destination of the data to be transferred, and a direction indicator for each scatter gather list element in the first scatter gather list data structure, where the direction indicator specifies whether the disk location is source and the part of the main memory is destination or specifies whether the disk location is destination and the part of the main memory is source.

Advantageouag embodiments of the device according to the present invention are defined in the sub-claims.

Further, the invention also relates to a computer readable medium having stored thereon instructions for causing one or more processing units to execute the method according to the present invention.

In the following, a first scatter gather list data structure is denoted Disk Input SGL (201)/SGL1, a second scatter gather list data structure is denoted Memory Input SGL (202)/SGL2, a third scatter gather list data structure is denoted Output Memory SGL (230)/SGL7, a fourth scatter gather list data structure is denoted Output Disk SGL(231)/SGL8, a fifth scatter gather list data structure is denoted Disk Input SGL (208)/SGL5, a sixth scatter gather list data structure is denoted Memory Input SGL (209)/SGL6, a seventh scatter gather list data structure is denoted Disk Output SGL (232)/SGL4, an eight scatter gather list data structure is denoted Memory Output SGL (233)/SGL3.

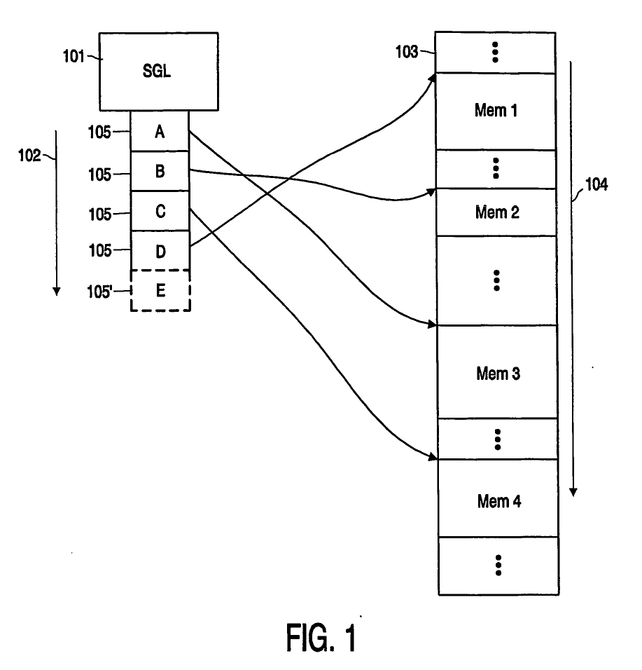

FIG. 1 schematically illustrates a Scatter-Gather List (SGL);

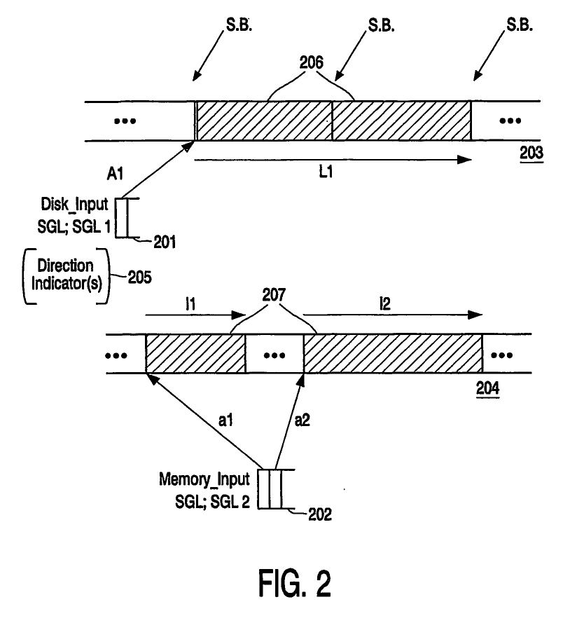

FIG. 2 illustrates SGLs used as part of a transfer according to the present invention;

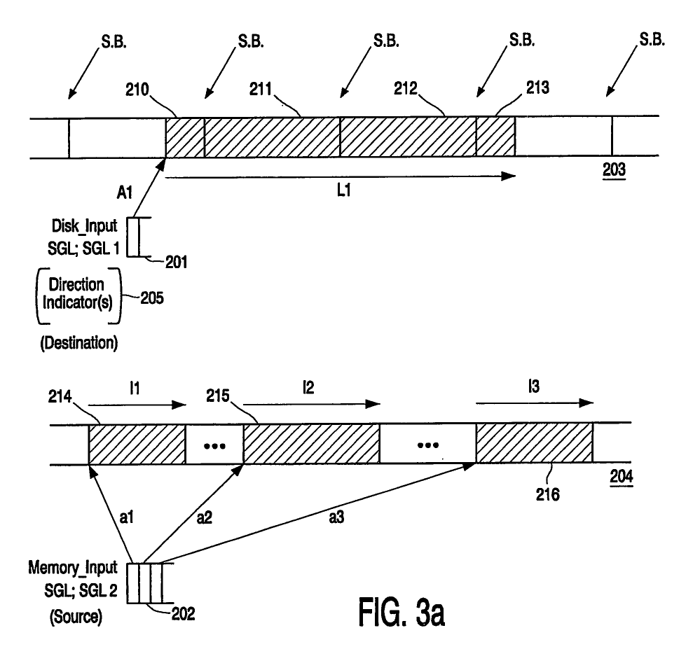

FIGS. 3a and 3b illustrates SGLs used as part of a transfer according to the present invention in connection with partial block read/write;

FIG. 3a illustrates SGLs before sector alignment according to the present invention has been performed;

FIG. 3b illustrates SGLs after sector alignment according to the present invention has been performed;

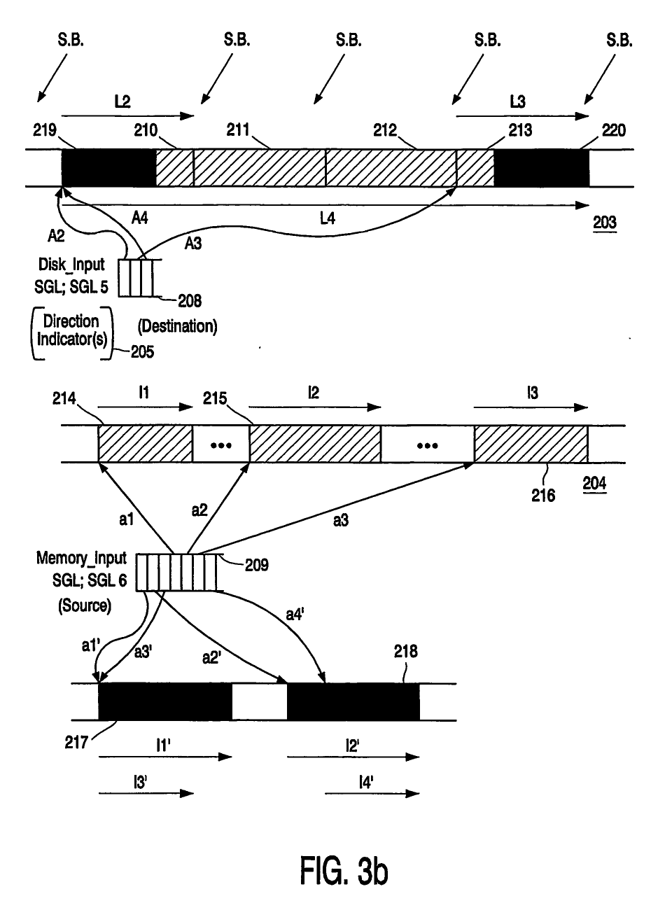

FIG. 4 schematically illustrates layers of an interface according to an embodiment of the present invention;

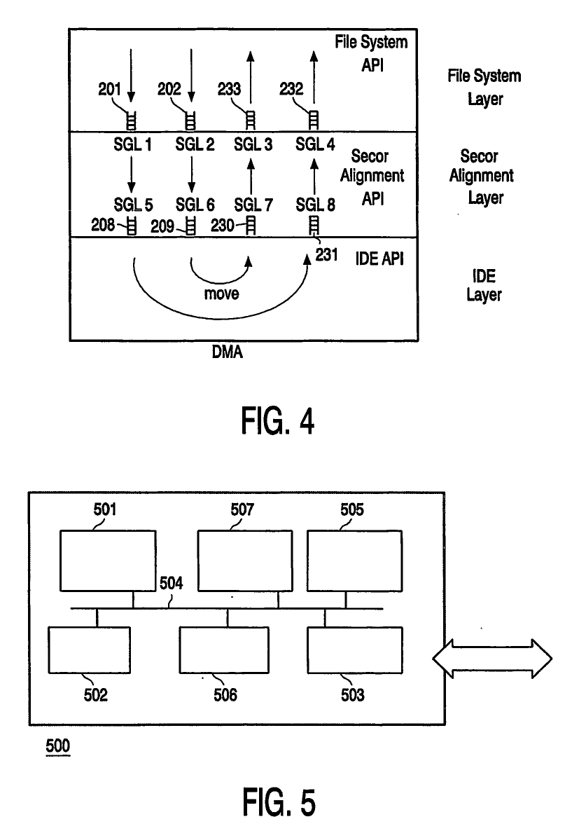

FIG. 5 schematically illustrates one example of a device according to an embodiment of the present invention.

FIG. 1 schematically illustrates a Scatter-Gather List (SGL). The SGL (101) is used to describe a logical sequence of data as indicated by the arrow (102). The sequence of data may be scattered over the main memory (103) or, according to the present invention, a disk of a storage device (103). The data described by the SGL (101) may be located in data areas of different or same size. The memory/disk address order is indicated by an arrow (104).

The particular SGL instantiation (101) in this Figure has a fixed number of scatter-gather units (105, 105′), designated ‘A’, ‘B’, ‘C’, ‘D’ and ‘E’, and describes the logical sequence of data as stored in memory/disk locations (103) Mem3, Mem2, Mem4 and Mem1 in that particular order. The SGL instantiation (101) is not completely filled, as one additional contiguouag data area can be appended, i.e. in SG-unit ‘E’ (105′). Note that the order (102) of the logical data (‘A’, ‘B’, ‘C’, ‘D’) does not have to be the same as the memory/disk-address order (104). Further note that the shown units ‘A’ through ‘E’ are internal to the SGL (101).

An SGL is according to the present invention implemented as a FIFO (first in first out) queue comprising SG-units (105; 105′), where each unit is a contiguouag piece of memory and has a reference to a start address (e.g. by using a pointer, an address offset, etc.) of a memory/disk location and specifies the size or length, etc. of the data stored at that particular memory/disk location usually expressed in terms of bytes. The SG-units are simple tuples (a, l), where ‘a’ designates the start address and ‘l’ the length. There are no alignment restrictions on address and/or length for SGLs.

No actual data of the memory/disk location is stored in an SGL or transferred between SGLs. Only the tuple is stored or transferred, which greatly reduces storage and bandwidth requirements.

In short, an SGL is an efficient way of referencing data stored in a memory or according to the present invention on a disk, even if the data is scattered/non-contiguous.

In the following, small letters are used for tuples relating to main memory while capital letters are used for tuples relating to disk/storage memory, i.e. (aᵢ, lᵢ) and (Aⱼ, Lⱼ), respectively.

According to the present invention, a Direction Indicator (not shown) has to be specified, where it is used to specify whether the disk location is source and the part of the main memory is destination or the other way around. Preferably, each tuple in an SGL for a disk comprises a Direction Indicator (not shown) that specifies the direction of the transfers described by that particular tuple, as will be explained in greater detail in the following. Preferably, the Direction Indicator is implemented by a single bit Preferably, one of the bits in the 64-bit disk addresses may be used since they are unused, since in for example ATA6 the size of an LBA is 48 bit and a sector is 512 bytes. This leaves 64−48−9=7 bits, where one of them may be used as the Direction Indicator for a given tuple of the Disk SGL. Alternatively, another unused bit may be used e.g. for other file controllers, like SCSI, etc. As another alternative, the Direction Indicator may also be stored in another way, e.g. as a separate SGL, in each tuple in a main memory SGL, etc.

FIG. 2 illustrates SGLs used as part of a transfer according to the present invention. Shown are a Memory Input SGL (202) (corresponds to SGL2 in FIG. 4) and a Disk Input SGL (201) (corresponds to SGL1 in FIG. 4). The Memory Input SGL (202) contains the tuples (a1, l1) and (a2, l2) and thereby references a (scattered) data area (207) to store data in (if reading from the disk) or to be read from (if writing to the disk) in the main memory (204) at address a1 having a length l1 and at address a2 having a length l2.

The Disk Input SGL (201) contains the tuple (A1, L1) and thereby references a data area (206) of the storage device (203) where data (207) being referenced by the Memory Input SGL (202) is to be stored (if writing to disk) or where data is located and is to be stored in the data area being referenced the Memory Input SGL (202) (if reading from disk). The data of the Disk Input SGL (201) is in this example contiguouag but may according to an aspect of the present invention be scattered. The Disk Input SGL (201) also comprises a ‘Direction Indicator’ (205) according to the present invention for each tuple stored in the Disk Input SGL (201), i.e. one for this example. Preferably, this Direction Indicator (205) is implemented by a single bit as explained above. The Direction indicator (205) specifies if data referenced by a given tuple of a Disk SGL is to be transferred from the storage device (203) to the main memory (204) or vice versa In this way, a simple and small indicator of the direction of the transfer is obtained using only an existing surplus bit for each tuple and enabling an efficient sector alignment as will be explained in the following.

Also indicated in connection with the storage device (203) are indications of sector boundaries (S.B.). In this particular simple example, the data area (206) of the storage device (203) being used either for reading or writing (as being given by the Direction indicator (205)) starts and ends at a sector boundary, i.e. no partial block read/write is necessary.

During operation, read, write and modify (which is a combination of read and write) commands are simply handled by queuing tuples to the Disk Input SGL (201) and the Memory Input SGL (202) and setting the Direction indicator (205) for each tuple in the Disk Input SGL (201) to specify what is source and what is destination of the main memory and the disk.

After ‘enough’ is in the memory and disk SGLs, actual transfers, i.e. the physical transfer of data, can take place asynchronously under the control of a storage control layer and/or an interface like IDE, ATA, etc. The tuples of the SGLs (201, 202) need to be translated into standard ATA/IDE commands. ‘Enough’ is preferably dependent on at least one pre-determined criterion, e.g. a given time period lapsed since last actual transfer and/or a given size of the total amount of data represented by the SGLs and so on. The usage of SGLs according to the present invention describes sort of ‘virtual’ transfers between main memory and disk of a storage device and when ‘enough’ data is present actual physical transfers take place.

In this simple example, a transfer command to transfer the contents of the data area (207) of the main memory (given by a1 ,l1 and a2,l2) to the specified data area (206) of the storage device (starting at A1 and having a length of L1), i.e. a write command in the traditional sense, would cause the two tuples (a1, l1) and (a2, l2) to be put in the Memory Input SGL and the tuple (A1, L1) to be put in the Disk Input SGL while the Direction indicator (205) of the tuple (A1, L1) of the Disk Input SGL is set to specify that the direction is from the main memory to storage device, e.g. simply by setting (or alternatively by clearing) a bit, as explained above. In this example L1 is equal to l1+l2.

When the actual transfer takes place, e.g. after other write, read and/or modify commands have caused more tuples to be added to the SGLs, the specific content of the data area (207) in the main memory is stored in the data area (206) of the storage device. The inherent FIFO structure of the SGLs according to the present invention ensures that variouag commands are handled in the correct order.

For a transfer command specifying to transfer the respective contents the other way around (a read command in the traditional sense), i.e. from the storage device to the main memory, only the value of the Direction indicator (205) of the tuple (A1, L1) of is changed. The same tuples should be put in the SGLs.

In short, a read or write process is handled by specifying a data area (206) of the storage device (preferably using one or more tuples in the Disk Input SGL) and specifying a data area (207) of the main memory (using one or more tuples in the Memory Input SGL) and the value of the Direction indicator (205) preferably stored for each tuple in the Disk Input SGL, where the specific value of the Direction indicator (205) specifies whether it is a read (i.e. transferring from storage device to main memory) or write (i.e. transferring from main memory to storage device) process for the particular one or more tuples of the Disk Input SGL (201) and the one or more corresponding tuples of the Memory Input SGL (202).

In this way, it is possible in a storage system to enable read/write operations in a very simple and efficient way. Even if the operations are based on partial blocks/sectors, as will be explained in connection with FIGS. 3a and 3b.

FIGS. 3a and 3b illustrates SGLs used as part of a transfer according to the present invention in connection with partial block read/write.

FIG. 3a illustrates SGLs before sector alignment according to the present invention has been performed. Shown are a Memory Input SGL (202) (corresponding to the Memory Input SGL in FIG. 2) and a Disk Input SGL (201) (corresponding to the Disk Input SGL in FIG. 2), but for another exemplary situation. This exemplary situation illustrates a partial block read/write operation. In this specific example, the direction of the transfer, as specified by the Direction indicator (205), is from main memory (204) to the disk/storage device (203), i.e. a write operation. The write concerns a partial block (210) followed by two full blocks (211, 212) followed by another partial block (213), where all the blocks (210-213) are contiguouag on the storage device and start at address A1 and have a total length of L1 as given by the tuple (A1, L1) in the Disk Input SGL (201). The source main memory locations are scattered and consist of three units (214, 215, 216) as given by the tuples (a1, l1), (a2,l2) and (a3,l3) in the Memory Input SGL (202). The dashed areas are thus described by the input SGLs (201, 202) and there is no alignment with sector boundaries. L1 is in this example equal to the sum of l1, l2 and l3 since the length of source and destination must be the same for doing access to a storage device. The input SGLs (201, 202) may as described earlier contain more data, but that data is not shown or discussed in order to simplify the example.

As mentioned an SGL is basically implemented as a queue of such tuples, providing additional operations and optimizations as well.

A1 points somewhere in a sector between two sector boundaries (S.B.) where the first part of that sector is to be untouched while the second part (210) is to be modified as indicated by a dashed area. As previously mentioned, reading (and writing) from disk can only be done in integral numbers of sectors. The addresses a1, a2 and a3 can point anywhere in main memory, provided this memory is accessible to the hard- and/or software doing the transfer.

The process of sector alignment is further explained in connection with FIG. 3b.

FIG. 3b illustrates SGLs after sector alignment according to the present invention has been performed. Shown are a Memory Input SGL (209) (corresponding to SGL 6 in FIG. 4) and the Disk Input SGL (208) (corresponding to SGL 5 in FIG. 4) and their associated memories (203, 204), respectively, after sector alignment has been performed and the Disk memory (203) no longer contains any partial block accesses. The Disk Input SGL (208) and the Memory Input SGL (209) in this Figure are generated on the basis of the Disk Input SGL (201 in FIG. 3a) and the Memory Input SGL (202 in FIG. 3a) in FIG. 3a by a sector alignment layer/application according to the present invention. As indicated in connection with FIG. 3a, the data content of the main memory is, in this example, to be transferred to the disk. A partial block read is much simpler to handle and will be explained later.

Also shown is temporary memory blocks (217, 218) being a part of the main memory and used in the sector alignment process. The temporary memory blocks (217, 218) have at least the same size as the storage device blocks/sectors and are used for ‘head’ and ‘tail’ for the partial blocks as explained in the following.

The sector alignment results in added sector parts (219, 220) that are added at the start and at the end of the transfer, respectively, thereby giving complete blocks/sectors.

The Disk Input SGL (208) and the Memory Input SGL (209) are generated on the basis of the Disk Input SGL (201 in FIG. 3a) and the Memory Input SGL (202 in FIG. 3a) in FIG. 3a according to the following in order to perform sector alignment:

First the head sector of the disk is pre-fetched/read before any writing takes place as it contains data that is to be untouched (219) by the write/modify step (if the data to be transferred does not start at a sector boundary). This is done by en-queuing a tuple (a1′, l1′) in the Memory Input SGL (209) and by en-queuing a tuple (A2,L2) in the Disk Input SGL (208) and specifying in the Direction Indicator of (A2,L2) to read (i.e. the disk is source and main memory is destination for the data referenced by (A2,L2)/(a1′,l1′)). The tuple (a1′,l1′) references data in the temporary memory block (217).

Then the tail sector of the disk is pre-fetched/read (if the data to be transferred does not end at a sector boundary) in this embodiment also before any writing takes place as it also contains data to be untouched (220).

This is done by en-queuing a tuple (a2′,l2′) in the Memory Input SGL (209) and by en-queuing a tuple (A3,L3) in the Disk Input SGL (208) and specifying in the Direction Indicator of (A3,L3) to read (i.e. the disk is source and main memory is destination for the data referenced by (A3,L3)/(a2′,l2′)). The tuple (a2′,l2′) references data in the temporary memory block (217).

In general, the reading of the tail sector just has to be performed before writing data to the tail sector. It does not matter if the tuples (a2′,l2′) and (A3,L3) is en-queued before or after the tuples (a1′,l1′) and (A2,L2) as long as they are en-queued before any tuples defining a write to the tail sector are en-queued, which ensures that the data (219) of the head and the data (220) of the tail that is to be untouched remains so after writing.

After this, the head of the head sector (219), i.e. the part of the head sector that is to be untouched by the un-aligned writing, is written.

This is done by en-queuing a tuple (a3′,l3′) in the Memory Input SGL (209) where a3′ is equal to a1′ and l3′<l1′. More specifically, l3′ is equal to the length of a sector minus the length of the data (210) in the head sector that is to be written. Alternatively, l3′ may be determined as A1 (from the Disk Input SGL in FIG. 3a) minus A2.

After this, the new/modified data (214, 215, 216) is written.

This is done by en-queuing the tuples (a1, l1), (a2, l2) and (a3, l3) in the Memory Input SGL (209) from the Memory Input SGL (202) of FIG. 3a.

And finally the tail of the tail sector (220), i.e. the part of the tail sector that is to be untouched by the un-aligned writing, is written.

This is done by en-queuing a (a4′,l4′) in the Memory Input SGL (209) where l4′ is equal to the length of a sector minus the length of the data (213) in the tail sector that is to be written. a4′ is equal to a2′+the length of the data of the tail sector that is to be written. Please note, that a2′+l2′ is equal to a4′+l4′, i.e. they both end at the end of the tail sector.

The tuples (a3′,l3′), (a1, l1), (a2, l2), (a3, l3) and (a4′,l4′) are related to the disk by modifying the tuple (A1,L1) of the Disk Input SGL (201 in FIG. 3a) by en-queuing the tuple (A4,L4) where A4 is equal to A2 and L4 is equal to l3′+l1+l2+l3+l4′, i.e. the sum of the length of the data to be written/modified (214, 215, 216) and the part (219) of the head to be untouched and the part of the tail (220) to be untouched. The Direction Indicator for (A4,L4) is set to specify a write.

After this the tuples relating to the disk references/defines a sector aligned data area, which is ready for being transferred to a block/sector storage device. The SGLs (208, 209) may then be used as input for a suitable conversion mechanism to translate their content into command for the storage device interface, e.g. an IDE interface.

For reading of partial blocks, the added partial sectors (219, 220) are simple discarded when they are being fetched. For a partial block read (using the same data areas) the tuples in the SGLs would be (A4,L4) and (a3′,l3′), (a1,l1), (a2,l2), (a3,l3) and (a4′,l4′). However, for this the pre-fetching/reading of the head and tail is not needed. The data of the head of the head sector (219) and the data of the tail of the tail sector (220) is simply discarded after being read. In other words, reading every sector (219+210, 211, 212, 213+220) (in any appropriate order) from the storage device (506), discarding a part (219) of the head sector (219+210) that does not comprise any of the data to be transferred if the data to be transferred does not start at a sector boundary (S.B.), and discarding a part (220) of the tail sector (213+220) that does not comprise any of the data to be transferred if the data to be transferred does not end at a sector boundary (S.B.), where the reading is represented by scatter gather list elements (105) in the Input Disk Input SGL (208) and the Memory Input SGL (209).

If the data to be transferred do start at a sector boundary, then (A2;L2) and (a1′,l1′) and (a3′,l3′) are omitted/not generated, and A4=A1.

If the data to be transferred do end at a sector boundary, then (A3;L3), (a2′,l2′) and (a4′,l4′) are omitted/not generated, and A4+L4=A1+L1, i.e. they end at the same place.

The described sector alignment process do not block the CPU as is the case for the previously described prior art process, since the task(s) of the CPU is de-coupled from the relatively much slower Disk I/O, as opposed to the three steps of prior art, where Disk I/O is needed after each step.

Further, no actual data is copied, since only references to the data, i.e. tuples, are copied between SGLs which greatly reduces storage and bandwidth requirements.

In the sector alignment according to the present invention, the “modifying” part now happens “automatically”, because the main memory is now part of the read as well as the write commands. The only restriction now is that the write may only take place after the read has resulted in the requested data in the requested memory locations. Such restrictions are easily handled by a disk scheduler on top of the storage device, as already known. That scheduler can now also easily optimize the throughput of the storage device.

In a situation where the entire data area referenced by a tuple in the Disk Input SGL (201 in FIG. 3a) is within a single sector it is only necessary to pre-fetch once and not twice as above, since this sector is both head and tail. In this situation the pre-fetch has to be done before any writing. The sector alignment process may then e.g. be reading the single sector from the storage device (506) and store it in a temporary sector (217; 218), and after the single sector is read writing the head of the single sector if the data to be transferred does not start at a sector boundary (S.B.), writing the data to be transferred, and writing the tail of the single sector if the data to be transferred does not end at a sector boundary (S.B.).

The function of the variouag tuples is summarised in the following table:

| Unit | Description |
|---|---|
| (a1′, l1′) | Head sector. Is a temporary buffer that can hold |
| | exactly one sector. For a1′, no sector alignment |
| | requirements hold. Corresponds to (A2, L2). Read. |
| (a2′, l2′) | Tail sector. Idem. Corresponds to (A3, L3). Read. |
| (a3′, l3′) | The head of the head sector. The part of the sector |
| | that may not be touched. So, a3′ is equal to a1′, |
| | but l3′ < l1′. Write. The units a3′, a1, a2, |
| | a3, a4′ correspond to (A4, L4). |
| (a1, l1) | Is the original (a1, l1) from FIG. 3a. Write. |
| (a2, l2) | Is the original (a2, l2) from FIG. 3a. Write. |
| (a3, l3) | Is the original (a3, l3) from FIG. 3a. Write. |
| (a4′, l4′) | The tail of the tail sector. The part of the sector |
| | that may not be touched. Note that a2′ + l2′ |
| | is equal to a4′ + l4′, they both end at the |
| | end of the tail sector. Write. |

FIG. 4 schematically illustrates layers of an interface according to an embodiment of the present invention. Shown are a Storage system Layer/File Administration Layer, a Sector Alignment Layer, a Disk Interface/IDE Layer, and a DMA engine or the like. Further shown are a Disk Input SGL/SGL1 (201) corresponding to the one in FIGS. 2 and 3a, a Memory Input SGL/SGL2 (202) corresponding to the one shown in FIGS. 2 and 3a, another Disk Input SGL (208)/SGL5 corresponding to the one shown in FIG. 3b, another Memory Input SGL (209)/SGL6 corresponding to the one shown in FIG. 3b.

In a preferred embodiment, an additional output Memory SGL (230) is used to describe the main memory that already has been part of an actual transfer, i.e. after any sector alignment if needed. Each transfer ‘moves’ memory from the Input Memory SGL (209) to the output Memory SGL/SGL 7 (230). The data itself is not moved, only a description of it, i.e. the relevant tuple(s). Further, is an additional Output Disk SGL/SGL8 (231 of FIG. 4) used to describe the disk location(s) that already has/have been part of an actual transfer in a similar manner.

In other words, after part of a transfer has taken place, that part is moved from the input SGLs (208, 209) to the corresponding output SGLs (231, 230), i.e., from SGL 5 to 8, and SGL 6 to 7 as shown in FIG. 4. This allows for easy and simple monitoring of the transfer processes that have taken place, which may be useful for variouag applications, other processes, etc.

In a further embodiment, the Sector Alignment Layer also comprises reverse processing that takes place on the output SGLs 7 (230) and 8 (231), in order to recycle the temporary memory of the temporary head and tail sectors (217 and 218 in FIG. 3b), and make its output SGLs 3 (233) and 4 (232) consistent with the original input SGLs 2 (202) and 1 (201). This allows for easy re-use of used memory in a very simple manner.

Some bits in the 64-bit disk addresses are unused, since in ATA6 the size of an LBA is 48 bit and a sector is 512 bytes. This leaves 64−48−9=7 bits, where one of the bits may be used as the Direction Indicator, as explained earlier. Unaligned write accesses are translated into (aligned) read accesses (of head and tail sectors) followed by aligned write accesses, as described in connection with FIGS. 3a and 3b. In order to keep it simple, the result of such a translation is again a single SGL, but the read requests have, in one embodiment, the unused bit set (a cleared bit thereby signifying a write). Alternatively, a cleared bit may signify a read request. The IDE/Disk Layer ensures that the read requests have finished before writing the data that was just read to the disk. Whenever, the direction indicator of SGL 5 (208) and/or SGL 6 (209) changes, then it should be ensured that a read is finished before writing whenever they are accessing the same memory location. This may be important especially for network storage devices.

Any half-word alignment requirement that may exist due to hardware requirements is dealt with in the normal way.

FIG. 5 schematically illustrates one example of a device according to an embodiment of the present invention. Shown is a device (500) according to an embodiment of the present invention, the device (500) comprising one or more micro-processors (501) connected with a main memory (502) and at least one storage device (506) via an internal data/address bus (504) or the like. Additionally, the device (500) may also be connected to or comprise a display (507) and/or communication means (501) for communication with one or more remote systems via a network. The memory (502) and/or storage device (506) are used to store and retrieve the relevant data together with executable computer code for providing the functionality according to the invention. The micro-processor(s) (501) is responsible for generating, handling, processing etc. of the SGLs according to the present invention.

The storage device (506) comprises one or more storage devices capable of reading and possibly writing blocks of data, e.g. a DVD, CD, optical disc, PVR, etc. player/recorder and/or a hard disk (IDE, ATA, etc), floppy disk, smart card, PCMCIA card, etc. The storage device may also be a network disk.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of representing a transfer of data between a main memory (502) and a storage device (506) in a storage system, the storage system comprising
a first scatter gather list data structure (201; SGL1) arranged to comprise zero or more scatter gather list elements (105) referencing a disk location (203) that is either source or destination of the data to be transferred,
a second scatter gather list data structure (202; SGL2) arranged to comprise zero or more scatter gather list elements (105) referencing a part of the main memory (204) that is either source or destination of the data to be transferred, and
a direction indicator (205) for each scatter gather list element (105) of the first scatter gather list data structure (201; SGL1) or for each scatter gather list element of the second scatter gather list data structure (202; SGL2), where the direction indicator (205) specifies whether the disk location (203) is source and the part of the main memory (204) is destination or specifies whether the disk location (203) is destination and the part of the main memory (204) is source,
the method comprising the step of generating
a first scatter gather list data structure (201; SGL1) and a second scatter gather list data structure (202; SGL2).

2. A method according to claim 1, characterized in that the first scatter gather list data structure (201; SGL1) comprises the direction indicator (205) or in that the second scatter gather list data structure (202; SGL2) comprises the direction indicator (205).

3. A method according to claim 1, characterized in that the method further comprises when performing a read or write operation
receiving a destination data area, a source data area and a direction,
en-queuing at least one scatter gather list element (105), comprising the destination data area dependent on the direction, in the first scatter gather list data structure (201; SGL1),
en-queuing at least one scatter gather list element (105), comprising the source data area dependent on the direction, in the second scatter gather list data structure (202; SGL2), and
setting the direction indicator (205) to specify which of the main memory and the storage device is source and destination.

4. A method according to claim 1, characterized in that the storage system further comprises
a fifth scatter gather list data structure (208; SGL 5)
a sixth scatter gather list data structure (209; SGL6),
and wherein the method further comprises a step of performing sector alignment of data to be transferred (214, 215, 216) prior to an unaligned write to the storage device (506), the step comprising:
reading a head sector (219+210) from the storage device (506) if the data to be transferred does not start at a sector boundary (S.B.) and storing it in a temporary head sector (217),
reading a tail sector (213+220) from the storage device (506) if the data to be transferred does not end at a sector boundary (S.B.) and storing it in a temporary tail sector (218), and
after the head and tail sector (219+210; 213+220) is read
writing the head (219) of the head sector (219+210) if the data to be transferred does not start at a sector boundary (S.B.),
writing the data to be transferred (214, 215, 216), and
write the tail (220) of the tail sector (213+220) if the data to be transferred does not end at a sector boundary (S.B.),
where the reading and writing is represented by scatter gather list elements (105) in the fifth (208; SGL 5) and the sixth (209; SGL6) data structure.

5. A method according to claim 1, characterized in that
the first scatter gather list data structure (201; SGL1) comprises one scatter gather list element (105) referencing data to be transferred within a single sector of a disk location (203) and the storage system comprises
a fifth scatter gather list data structure (208; SGL 5)
a sixth scatter gather list data structure (209; SGL6),
and wherein the method further comprises a step of performing sector alignment of data to be transferred (214, 215, 216) prior to an unaligned write to the storage device (506), the step comprising:
reading a single sector from the storage device (506) and store it in a temporary sector (217; 218), and
after the single sector is read
writing the head of the single sector if the data to be transferred does not start at a sector boundary (S.B.),
writing the data to be transferred, and
write the tail of the single sector if the data to be transferred does not end at a sector boundary (S.B.),
where the reading and writing is represented by scatter gather list elements (105) in the fifth (208; SGL 5) and the sixth (209; SGL6) data structure.

6. A method according to claim 1, characterized in that the storage system further comprises
a fifth scatter gather list data structure (208; SGL 5),
a sixth scatter gather list data structure (209; SGL6),
and wherein the method further comprises a step of performing an unaligned read of data to be transferred (210, 211, 212, 213) from the storage device (506), the step comprising:
reading every sector (219+210, 211, 212, 213+220) from the storage device (506),
discarding a part (219) of the head sector (219+210) that does not comprise any of the data to be transferred if the data to be transferred does not start at a sector boundary (S.B.), and
discarding a part (220) of the tail sector (213+220) that does not comprise any of the data to be transferred if the data to be transferred does not end at a sector boundary (S.B.),
where the reading and writing is represented by scatter gather list elements (105) in the fifth (208; SGL 5) and the sixth (209; SGL6) data structure.

7. A method according to claim 1, characterized in that the storage system further comprises
a third scatter gather list data structure (230; SGL7) comprising one or more scatter gather list elements (105) referencing a part of the main memory (204) that is either source or destination of the data to be transferred,
a fourth scatter gather list data structure (231; SGL8) comprising one or more scatter gather list elements (105) referencing a disk location (203) that is either source or destination of the data to be transferred,
and wherein the method further comprises a step of when a part of a transfer has taken place, then transferring reference to data of that part from the sixth data structure (201) to the third data structure (233) and transferring data of that part from the fifth data structure (202) to the fourth data structure (232).

8. A method according to claim 7, characterized in that the storage system further comprises
a seventh scatter gather list data structure (233; SGL3) comprising one or more scatter gather list elements (105) referencing a part of the main memory (204) that is either source or destination of the data to be transferred,
an eighth scatter gather list data structure (232; SGL4) comprising one or more scatter gather list elements (105) referencing a disk location (203) that is either source or destination of the data to be transferred,
and wherein the method further comprises a step of
performing reverse processing on the third scatter gather list data structure (230; SGL7) and the fourth scatter gather list data structure (231; SGL8), in order to recycle the temporary memory of the temporary head sector (217) and/or the temporary tail sector (218),
generating the seventh scatter gather list data structure (233; SGL3) to make it consistent with the second scatter gather list data structure (202; SGL2) on the basis of the reverse processing, and
generating the eighth scatter gather list data structure (232;
SGL4) to make it consistent with the first scatter gather list data structure (201; SGL1) on the basis of the reverse processing.

9. A method according to claim 1, characterized in that said direction indication (105) is implemented as a single surplus bit among bits of a computer representation of the disk addresses according to ATA6.

10. A method according to claim 1, characterized in that said storage system is a real time storage system.

11. A device for representing a transfer of data between a main memory and a storage device in a storage system, the storage system comprising
a first scatter gather list data structure (201; SGL1) arranged to comprise zero or more scatter gather list elements (105) referencing a disk location (203) that is either source or destination of the data to be transferred,
a second scatter gather list data structure (202; SGL2) arranged to comprise zero or more scatter gather list elements (105) referencing a part of the main memory (204) that is either source or destination of the data to be transferred, and
a direction indicator (205) for each scatter gather list element (105) of the first scatter gather list data structure (201; SGL1) or for each scatter gather list element of the second scatter gather list data structure (202; SGL2), where the direction indicator (205) specifies whether the disk location (203) is source and the part of the main memory (204) is destination or specifies whether the disk location (203) is destination and the part of the main memory (204) is source.

12. A device according to claim 11, characterized in that the first scatter gather list data structure (201; SGL1) comprises the direction indicator (205) or in that the second scatter gather list data structure (202; SGL2) comprises the direction indicator (205).

13. A device according to claim 11, characterized in that the device is adapted to when performing a read or write operation
receive a destination data area, a source data area and a direction,
en-queuing at least one scatter gather list element (105), comprising the destination data area dependent on the direction, in the first scatter gather list data structure (201; SGL1),
en-queuing at least one scatter gather list element (105), comprising the source data area dependent on the direction, in the second scatter gather list data structure (202; SGL2), and
set the direction indicator (205) to specify which of the main memory and the storage device is source and destination.

14. A device according to claim 11, characterized in in that the storage system further comprises
a fifth scatter gather list data structure (208; SGL 5)
a sixth scatter gather list data structure (209; SGL6),
and wherein the device is further adapted to perform a step of sector alignment of data to be transferred (214, 215, 216) prior to an unaligned write to the storage device (506), the step comprising:
reading a head sector (219+210) from the storage device (506) if the data to be transferred does not start at a sector boundary (S.B.) and storing it in a temporary head sector (217),
reading a tail sector (213+220) from the storage device (506) if the data to be transferred does not end at a sector boundary (S.B.) and storing it in a temporary tail sector (218), and
after the head and tail sector (219+210; 213+220) is read
writing the head (219) of the head sector (219+210) if the data to be transferred does not start at a sector boundary (S.B.),
writing the data to be transferred (214, 215, 216), and
write the tail (220) of the tail sector (213+220) if the data to be transferred does not end at a sector boundary (S.B.),
where the reading and writing is represented by scatter gather list elements (105) in the fifth (208; SGL 5) and the sixth (209; SGL6) data structure.

15. A device according to claim 11, characterized in that the first scatter gather list data structure (201; SGL1) comprises one scatter gather list element (105) referencing data to be transferred within a single sector of a disk location (203) and the storage system comprises
a fifth scatter gather list data structure (208; SGL 5)
a sixth scatter gather list data structure (209; SGL6),
and wherein the device is further adapted to perform a step of sector alignment of data to be transferred (214, 215, 216) prior to an unaligned write to the storage device (506), the step comprising:
reading a single sector from the storage device (506) and store it in a temporary sector (217; 218), and
after the single sector is read
writing the head of the single sector if the data to be transferred does not start at a sector boundary (S.B.),
writing the data to be transferred, and
write the tail of the single sector if the data to be transferred does not end at a sector boundary (S.B.),
where the reading and writing is represented by scatter gather list elements (105) in the fifth (208; SGL 5) and the sixth (209; SGL6) data structure.

16. A device according to claim 11, characterized in that said device is further adapted to perform a step of an unaligned read of data to be transferred (210, 211, 212, 214) from the storage device (506), the step comprising:
reading a every sector (219+210, 211, 211, 213+220) from the storage device (506),
discarding a part (219) of the head sector (219+210) that does not comprise any of the data to be transferred if the data to be transferred does not start at a sector boundary (S.B.), and
discarding a part (220) of the tail sector (213+220) that does not comprise any of the data to be transferred if the data to be transferred does not end at a sector boundary (S.B.),
where the reading and writing is represented by scatter gather list elements (105) in the fifth (208; SGL 5) and the sixth (209; SGL6) data structure.

17. A device according to claim 11, characterized in that the storage system further comprises
a third scatter gather list data structure (230; SGL7) comprising one or more scatter gather list elements (105) referencing a part of the main memory (204) that is either source or destination of the data to be transferred,
a fourth scatter gather list data structure (231; SGL8) comprising one or more scatter gather list elements (105) referencing a disk location (203) that is either source or destination of the data to be transferred,
and wherein the device is further adapted to
when a part of a transfer has taken place, then transferring reference to data of that part from the first data structure (201) to the third data structure (233) and transferring data of that part from the second data structure (202) to the fourth data structure (232).

18. A device according to claim 17, characterized in that the storage system further comprises
a seventh scatter gather list data structure (233; SGL3) comprising one or more scatter gather list elements (105) referencing a part of the main memory (204) that is either source or destination of the data to be transferred,
an eighth scatter gather list data structure (232; SGL4) comprising one or more scatter gather list elements (105) referencing a disk location (203) that is either source or destination of the data to be transferred,
and wherein the device is further adapted to
perform reverse processing on the third scatter gather list data structure (230; SGL7) and the fourth scatter gather list data structure (231; SGL8), in order to recycle the temporary memory of the temporary head sector (217) and/or the temporary tail sector (218),
generate the seventh scatter gather list data structure (233; SGL3) to make it consistent with the second scatter gather list data structure (202; SGL2) on the basis of the reverse processing, and
generate the eighth scatter gather list data structure (232; SGL4) to make it consistent with the first scatter gather list data structure (201; SGL1) on the basis of the reverse processing.

19. A device according to claim 11, characterized in that said direction indication (105) is implemented as a single surplus bit among bits of a computer representation of the disk addresses according to ATA6.

20. A device according to claim 11, characterized in that said storage system is a real time storage system.

21. A computer readable medium having stored thereon instructions for causing one or more processing units to execute the method according to claim 1.
